(19) United States
(12) Patent Application Publication
(10) Pub. No.: US 2013/0075600 A1
(43) Pub. Date: Mar. 28, 2013

(54) NANOSTRUCTURED NEUTRON SENSITIVE MATERIALS FOR WELL LOGGING APPLICATIONS

(71) Applicants: Anton Nikitin, Houston, TX (US); Mikhail Korjik, Minsk (BY)

(72) Inventors: Anton Nikitin, Houston, TX (US); Mikhail Korjik, Minsk (BY)

(73) Assignee: BAKER HUGHES INCORPORATED, Houston, TX (US)

(21) Appl. No.: 13/242,839

(22) Filed: Sep. 23, 2011

(51) Int. Cl. G01V 5/10; G01T 3/06; G01N 23/22; B82Y 15/00

(52) U.S. Cl. 250/269.4; 250/390.06; 250/390.11; 977/954

(57) ABSTRACT

Disclosed is an apparatus for detecting a neutron. The apparatus includes: a neutron interaction material configured to emit a charged particle upon absorbing a neutron; a plurality of nanoparticles distributed in the neutron interaction material, each nanoparticle in the plurality being configured to scintillate upon interacting with the charged particle to emit a pulse of light; a photodetector coupled to the neutron interaction material and configured to receive the pulse of light and generate a signal based on the received pulse of light; and a processor configured to receive the signal in order to detect the neutron.

### BACKGROUND

Geologic formations are used for many purposes such as hydrocarbon production, geothermal production and carbon dioxide sequestration. In general, formations are characterized in order to determine if the formations are suitable for their intended purpose.

One way to characterize a formation is to convey a downhole tool through a borehole penetrating the formation. The tool is configured to perform measurements of one or more properties of the formation at various depths in the borehole to create a measurement log.

Many types of logs can be used to characterize a formation. In one type of log referred to as a neutron log, a neutron source and a neutron detector are disposed in a downhole tool. The neutron source is used to irradiate the formation and the neutrons resulting from interactions with atoms of the formation are detected with the neutron detector. A formation property such as density or porosity can be determined from the detected neutrons. It can be appreciated that improving the sensitivity of the neutron detector can improve the accuracy of the formation characterization.

### BRIEF SUMMARY

Disclosed is an apparatus for detecting a neutron. The apparatus includes: a neutron interaction material configured to emit a charged particle upon absorbing a neutron; a plurality of nanoparticles distributed in the neutron interaction material, each nanoparticle in the plurality being configured to scintillate upon interacting with the charged particle to emit a pulse of light; a photodetector coupled to the neutron interaction material and configured to receive the pulse of light and generate a signal based on the received pulse of light; and a processor configured to receive the signal in order to detect the neutron.

Also disclosed is an apparatus for estimating a property of an earth formation penetrated by a borehole. The apparatus includes: a carrier configured to be conveyed through the borehole; a neutron source disposed at the carrier and configured to irradiate the formation with neutrons; a neutron detector disposed at the carrier and configured to detect a neutron resulting from one or more interactions between the neutrons emitted from the neutron source and the formation, the neutron detector having a neutron interaction material configured to emit a charged particle upon absorbing a neutron and a plurality of nanoparticles distributed in the neutron interaction material, each nanoparticle in the plurality being configured to scintillate upon interacting with the charged particle to emit a pulse of light; and a photodetector coupled to the neutron interaction material and configured to detect the pulse of light and generate a signal upon detecting the pulse of light; wherein the signal is used to estimate the property.

Further disclosed is a method for estimating a property of an earth formation penetrated by a borehole. The method includes: conveying a carrier through the borehole; irradiating the formation with neutrons emitted from a neutron source; receiving neutrons resulting from interactions of the emitted neutrons with the formation using a neutron detector, the neutron detector having a neutron interaction material configured to emit a charged particle upon absorbing a neutron and a plurality of nanoparticles distributed in the neutron interaction material, each nanoparticle in the plurality being configured to scintillate upon interacting with the charged particle to emit a pulse of light; receiving the pulse of light with a photodetector to produce a signal; and estimating the property using the signal.

### BRIEF DESCRIPTION OF THE DRAWINGS

The following descriptions should not be considered limiting in any way. With reference to the accompanying drawings, like elements are numbered alike:

FIG. 1 illustrates an exemplary embodiment of a downhole neutron tool disposed in a borehole penetrating the earth;

FIG. 2 depicts aspects of a scintillation detector disposed at the downhole neutron tool;

FIG. 3 depicts aspects of relaxation of electronic excitations in scintillators containing Ce-3+ ions;

FIG. 4 depicts aspects of a scintillation process for a single crystal scintillator having impregnated nanocrystals;

FIG. 5 depicts aspects of a temperature program used to synthesize glass;

FIG. 6 depicts aspects of diffraction spectra of YAG:Ce (1 at. %) nanoparticles annealed at different temperatures;

FIG. 7 depicts aspects of room temperature radioluminescence spectra measured for YAG:Ce (1 at. %) and YAG:Ce (5 at. %) using a 57-Co (122 keV) gamma ray source;

FIG. 8 depicts aspects of radioluminescence spectra measured for two synthesized boron-silicate glasses; and

FIG. 9 one example of a method for estimating a property of an earth formation.

### DETAILED DESCRIPTION

Disclosed are apparatus and method for detecting neutrons in a downhole tool with improved sensitivity and, hence, accuracy. In one or more embodiments, neutrons detected during neutron well logging operations are used to estimate a property of an earth formation such as density or porosity using processing techniques known in the art.

A detailed description of one or more embodiments of the disclosed apparatus and method presented herein by way of exemplification and not limitation with reference to the Figures.

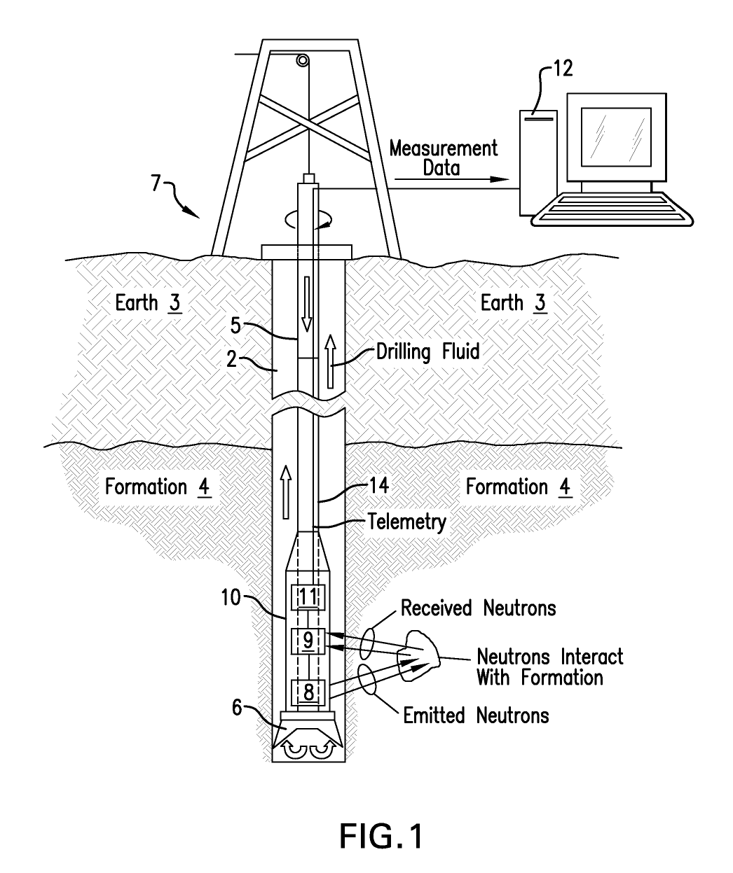

FIG. 1 illustrates an exemplary embodiment of a downhole neutron tool 10 disposed in a borehole 2 penetrating the earth 3, which includes an earth formation 4. The formation 4 represents any subsurface materials of interest. The downhole tool 10 is conveyed through the borehole 2 by a carrier 14. In the embodiment of FIG. 1, the carrier 14 is a drill string 5. Disposed at the distal end of the drill string 5 is a drill bit 6. A drilling rig 7 is configured to conduct drilling operations such as rotating the drill string 5 and thus the drill bit 6 in order to drill the borehole 2. The neutron tool 10 is configured to perform formation measurements while the borehole 2 is being drilling or during a temporary halt in drilling in an application referred to as logging-while-drilling (LWD). In an alternative logging application referred to as wireline logging, the carrier 4 is an armored wireline configured to convey the neutron tool 10 through the borehole 2.

Still referring to FIG. 1, the downhole neutron tool 10 includes a neutron source 8 configured to irradiate the formation 4 with a flux of neutrons. In one or more embodiments, the neutron source 8 includes a chemical neutron source. The neutron tool 10 also includes a neutron detector 9 configured to detect neutrons resulting from interactions of the neutron flux with atoms in the formation 4. From the detection of the neutrons resulting from the interactions, one of more properties, such as density or porosity, can be determined.

Still referring to FIG. 1, the neutron detector 9 is coupled to downhole electronics 11. The downhole electronics 11 are configured to operate the downhole tool 10, process data from formation measurements, and/or provide an interface for transmitting data to a surface computer processing system 12 via a telemetry system. In one or more embodiments, the downhole electronics 11 can provide operating voltages to the neutron detector 9 and measure or count electrical current pulses resulting from neutron detection. Processing functions such as counting detected neutrons or determining a formation property can be performed by the downhole electronics 11 or the surface computer processing system.

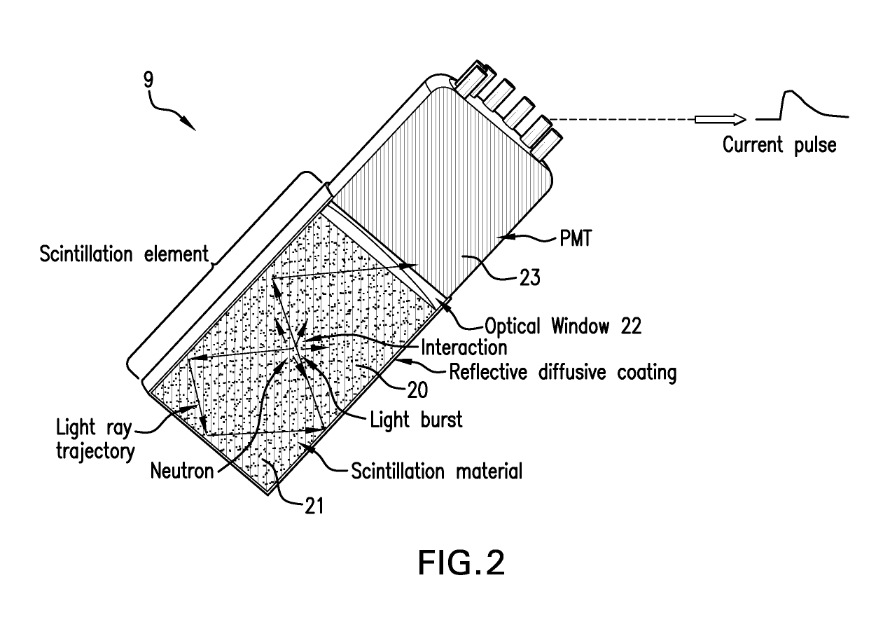

Reference may now be had to FIG. 2 depicting aspects of the neutron detector 9. The neutron detector 9 is a device for converting detected neutrons into the pulses of voltage or current, which can be registered by the electronics such as the downhole electronics 11. Such a conversion includes two stages. In a first stage, a detected neutron is absorbed in a neutron interaction material 20 that emits a charged particle(s) upon absorption of the neutron. In a second stage, energy carried by the charged particle(s) is converted into a current/voltage pulse. In one or more embodiments, the first stage of the neutron detection process can utilize one of the following nuclear reactions when the neutron interacts with the nucleus of a particular isotope in the neutron interaction material to emit the charged particle(s):

$$\begin{matrix}\begin{matrix}n + {}^{6} Li \to {}^{3} H ( 2.75 MeV ) + {}^{4} He ( 2.05 MeV ) ; & σ = 520 b\end{matrix} & ( 1 ) \\ \begin{matrix}n + {}^{10} B \to {}^{7} Li ( 1.0 MeV ) + {}^{4} He ( 1.8 MeV ) ; & BR = 7 \% \\ \to {}^{7} Li ( 0.83 MeV ) + {}^{4} He ( 1.47 MeV ) + γ ( 0.48 MeV ) ; & BR = 93 \%\end{matrix} \} {σ}_{tot} = 3840 b & ( 2 )\end{matrix}$$

Shown here are values of the reaction cross-section a for thermal neutrons with energy Eₙ=0.025 eV.

The second stage is based on a scintillation process that occurs based on the charged particle(s) interacting with a scintillation material 21. Moving through the scintillation material, the charged particle(s) experience losses of the energy due to ionization. Part of the lost energy is transferred into visible light emitted when excitons (i.e., electron-hole pairs) are relaxed at luminescent centers of scintillation. The emitted visible light is collected at an optical window 22 of a photodetector 23 such as photomultiplier tube (PMT), which converts the emitted visible light signal into the pulse of voltage/current.

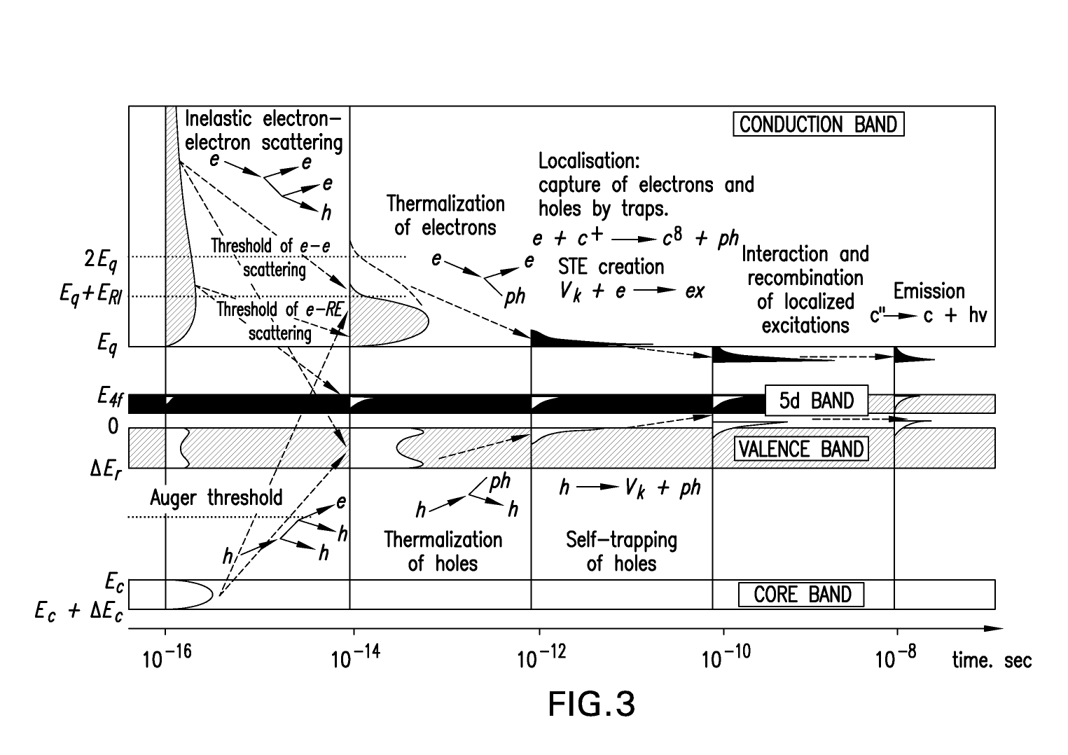

The scintillation process depends on the relaxation of the electronic excited states formed when the charged particle(s) interacts with the scintillation material 21. The average path of such particle(s) can be several microns long and multiple “hot” carriers are created along the charged particle trajectory due to ionization losses of its energy. The term “hot” relates to a particle or hole having an increase in its energy. The scheme illustrating relaxation of such “hot” carriers when the scintillation material is doped (or activated) with Ce (referred to as scintillator atoms) is shown in FIG. 3. In this case, the relaxation consists of four phases. In a multiplication phase, inelastic electron scattering and electron and hole multiplication (i.e., the creation of “hot” electrons and holes—electrons and holes with the energy much higher than the scintillation material band gap E_{g} value) occurs; in a thermalization phase, thermalization of the “hot” electrons and holes occurs. In a localization phase, localization of electrons and holes at Ce³⁺ ions occurs along with the formation of electron-hole pairs (i.e., excitons). In a recombination phase, radiative recombination of electron-hole pairs occurs with the emission of visible light photons.

The overall efficiency of the relaxation process defining the light yield (LY) of the scintillation process is determined as the conversion rate of the energy deposited by charged particles in the scintillation material into visible light photons. It is defined by the mechanisms of different phases of “hot” electron and hole relaxation. Parameters of these mechanisms depend on the electronic structure of the scintillation material, particularly, on the location of the 5d electronic energy levels of Ce³⁺ ions relatively to top and bottom of valence and conduction bands of the matrix material containing the scintillator atoms. Also, the concentration of different structural defects in the matrix material is important because such defects create local distortions of the electronic structure in the vicinity of Ce³⁺ ions which could decrease the efficiency of exciton formation and their radiative recombination decreasing the overall relaxation process efficiency.

The atomic structural properties of glass scintillation materials are different from the properties of crystalline scintillation materials. Because of the absence of long range ordering in the atomic structure of the glass, which is an amorphous material, the ability for the fast and efficient transport of exciton energy to radiating centers is limited. Moreover, a localization site of the activator's ion in the glass atomic structure is not very well defined. The dispersion of Ce³⁺ ion site structures in the glass appears due to their localization in slightly different chemical environments (several closest coordination shells formed by glass matrix atoms could have little bit different atomic structure). This splits energies of 5d states of Ce³⁺ ions which are very sensitive to a crystalline field depending on the localization site and, as the result, much wider and more disperse 5d radiating band is formed in the electronic structure of the glass scintillator in comparison with 5d band formed by Ce dopant in single crystal scintillation material. This fact and also a much higher probability of the structural defect presence in the vicinity of the Ce³⁺ ions which could trap thermalized charge carries and excitons and cause their nonradiative recombination in the case of glass explains why a typical value of LY for glass scintillation materials is much lower than typical value of LY for single crystal scintillators.

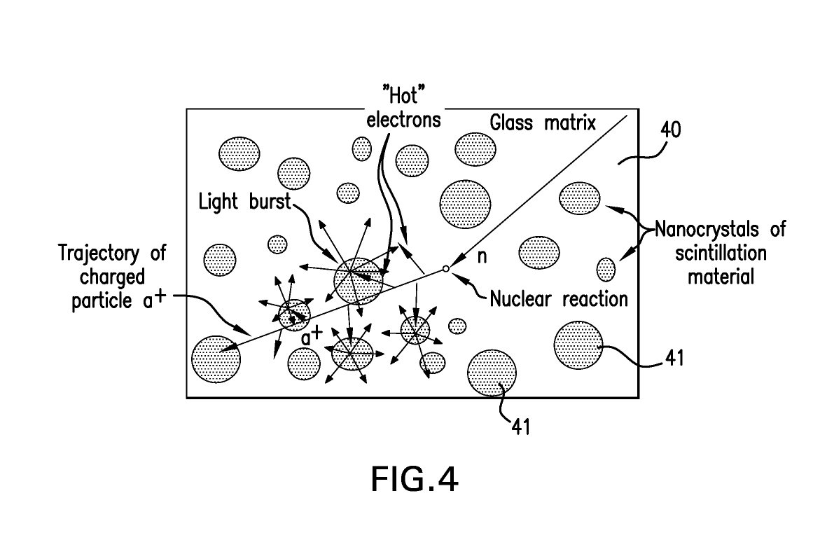

It should be pointed out that the relaxation of “hot” carriers created in the process of the interaction of charge particle with scintillation material is localized in an area extending approximately 100 nm from the trajectories of charges particles formed at the first stage of the neutron detection process. This localization of the relaxation process provides the opportunity to improve the performance of glass scintillators through the impregnation of the nano-sized single crystal scintillators (referred to as nanocrystals) into a glass matrix. In this case, for those “hot” electrons formed along the charged particle trajectory, the relaxation and light emission take place in the nanocrystals and are defined by the properties of the nanocrystals as illustrated in FIG. 4. FIG. 4 illustrates glass matrix 40 made with the neutron interaction material and scintillator nanocrystals 41 made with the scintillation material. The nanocrystals 41 allow decoupling of the first stage and the second stage of the detection process when neutron absorption takes place mainly the neutron interaction material in the glass matrix and scintillation takes place mainly in the nano crystals. As a result, better matching of the spectrum of the light emitted in the scintillation process and light adsorption spectrum of the glass itself can be reached minimizing self-absorption of emitted light on its way to the photodetector. Also, because of the dependence of LY on temperature in this case is mainly defined by the properties of scintillation material and dimensions of nanocrystals, there are more opportunities to synthesize a glass scintillator that does not suffer from rapid deterioration of LY at high temperature.

It should be pointed out that the above disclosure is very different from the idea behind composite neutron sensitive scintillators made of the mechanical mixture of B₂O₃ and ZnS:Ag particles of micron size. In the case of the mechanical mixture, the ¹⁰B enriched boron oxide works as neutron absorber and the ZnS:Ag particles convert Li⁺ and alpha particle (He⁺) species emitted in a neutron absorption reaction into visible light. The size of B₂O₃ and ZnS:Ag particles is chosen to be smaller than mean free path of alpha particle in these materials, which is about 2.5 um. As the result, the B₂O₃—ZnS:Ag composite scintillator has very low transparency due to light scattering at the boundaries of the material grains. Therefore this composite scintillator can be used only in the form of thin layer deposited at the surface of the PMT optical window.

The scintillation material based on scintillator nanocrystals impregnated into glass matrix does not suffer from this problem if the size of the nanocrystals is at least four times smaller than the wavelength of the light emitted in the scintillation process (approximately 400 nm (nanometer) for Ce³⁺ activated scintillators). Also, if the scintillator nanocrystal size is approximately 100 nm instead of 1 um (micron), much more uniform distribution of scintillation material inside of neutron absorption material (i.e., the glass matrix) can be reached and better performance parameters of the scintillation material can be obtained. Another benefit from the use of scintillation nanocrystals is related to the following nanoscale effect: scintillation material in the form of nanocrystals can be doped with higher amounts of Ce in comparison with the same scintillation material in the form of a single crystal volume due to the modification of the atomic structure of nanocrystals caused by the surface tension. The higher concentration of Ce in the scintillator increases the density of the 5d band in its electronic structure that increases the efficiency of the capture of thermalized charged carriers by Ce³⁺ ions. Moreover, isolation of nano-particles in the glass matrix from each other prevents migration quenching of the activator luminescence, which is one of the factors limiting scintillation light yield in single crystals.

In general, scintillation material with the structure illustrated in FIG. 4 can be obtained by several methods. One of the methods is based on the synthesis used to obtain glass ceramics materials. In this case, the glass is made from a raw glass material with a chemical composition that is close to the chemical composition of the desired nanocrystals. After melting, the glass is exposed to a temperature close to its verification temperature for an extended period of time. The main goal of this step is to form the seeds of the desired nanocrystals. After this, the glass is exposed to gradually increasing temperature. The main goal of this step is to promote the growth of the nanocrystals inside of the glass matrix.

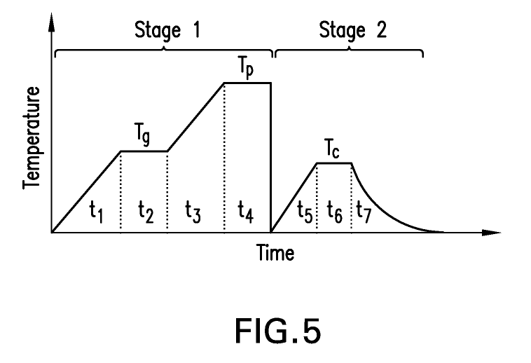

Another approach to synthesize the glass with the desired nanocrystal structure is to use a mixture of the scintillator nanocrystals and glass matrix material as a raw material for the glass synthesis. In order for the glass matrix material to be sensitive to neutron detection/absorption and have a high neutron detection efficiency, the glass matrix material contains relatively high concentrations of Lithium-6 and/or Boron-10 in one or more embodiments. The glass itself is synthesized by heating the raw materials according to the temperature program illustrated in FIG. 5.

Referring to FIG. 5, Stage 1 of the synthesis process relates to melting the glass matrix material to form a homogeneous glass structure. It includes of several steps. During time period t₁, the mixture is heated up to the temperature of vitrification T_{g} where different parts of the mixture start to smelt to each other and is kept at this temperature during time period t₂ to outgas the material. The duration of t₂ is different for different glasses and can vary from 0 to hundreds of hours. During time period t₃, the temperature of the material is increased up to the glass melting temperature Tₚ. The obtained glass melt is kept at this temperature during time period t₄ for its homogenization and, after this it is cooled very rapidly at a cooling rate greater than 500° C./min to a temperature at or above room temperature.

The main goal of Stage 2 of the synthesis process is to reconstruct scintillation nanocrystals in the glass matrix by annealing the glass obtained in Stage 1 at temperature T_{c}, which slightly below the vitrification temperature T_{g}. The temperature of glass sample is slowly increased during time period t₅. Then, the glass is annealed (or “recrystallized”) at constant temperature T_{c} during time period t₆. Also, the temperature T_{c} can be slowly increased during the recrystallization depending on the material. After annealing, the glass is slowly cooled down. If nanocrystals are not dissolved completely in the glass melt at Stage 1 (Requirement 1) and their fragments, which could contain only few crystal unit cells, are still present in the glass matrix, they (i.e., the fragments) start to play a role of seeds for crystallization during Stage 2 if (Requirement 2) chemical composition of the glass matrix surrounding such seeds allows the crystallization (i.e., the glass matrix in close proximity of nanocrystal seeds contains elements in necessary concentrations required for the crystallization or nanocrystal growth). Requirements 1 and 2 are crucial for the successful synthesis of the scintillation glass with impregnated scintillation nano crystals.

One approach to increase the probability of the successful nanocrystal recovery during Stage 2 of the synthesis process is to increase the concentration of nanocrystals in the initial mixture used to produce glass. But, too high of a concentration of nanocrystals in the mixture with the glass matrix material can cause avalanche recrystallization during the fast cooling step of Stage 1 of the synthesis process when almost all matter of the mixture is converted into the aggregation of crystallites with sizes exceeding 100 nm. As a result, instead of transparent glass, non transparent glass ceramics is produced. Another approach is to use the glass matrix material which constitutes the glass matrix with the elemental composition close to the composition of desired nanocrystals. This will help to meet Requirement 2 and as a result increase the probability of the successful recrystallization of nanocrystals at Stage 2 of the glass synthesis process. However, if glass matrix contains too much raw material for nanocrystal growth or temperature T_{C} is above the optimal value for a given glass composition, again the avalanche recrystallization occurs with the same consequences.

If Stage 1 of neutron detection uses nuclear reaction (2), then the glass matrix containing the nanostructured scintillation material is a boron-based glass containing substantial concentrations of Boron-10 isotope. In one or more embodiments, the general composition of the boron-based glass is M¹O₂—B₂O₃—M²₂O₃—MgO, where M¹=Si, Ge, M²=Y, La or rare earth metal ion from Pr to Lu. In this case, nanocrystals of garnet (Y₃Al₅O₁₂ or YAG) doped with Ce or Eu can be used as scintillator nanocrystals for the synthesis.

One method to synthesize nanocrystals of scintillators includes a two-step process. Step 1 includes precipitation of raw material to produce nanoparticles with desired chemical composition. Step 2 includes calcinations of the obtained precipitates.

For Step 1, NH₄HCO₃ was used as a precipitation agent in one embodiment. Solutions of Y and Al nitrates with the concentration of 1 mol per liter were mixed in appropriate proportion and combined with NH₄HCO₃ to obtain a stoichiometric composition of the defined chemical compound of the desired scintillator material. To dope nanoparticles with Ce, ions of corresponding chemical compounds were added into solutions used in the precipitation. YAG:Ce nanoparticles were obtained from the precipitation in Step 1. In this case, no hard agglomerates of garnet nanoparticles were observed and their average size was approximately 100 nm.

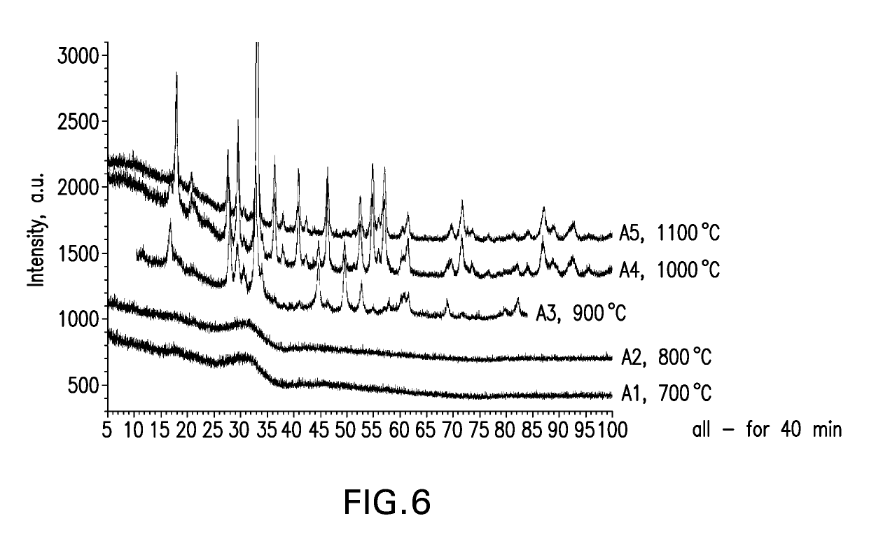

For Step 2, the material obtained at Step 1 is annealed at temperature in the range between 700° C. and 1300° C. depending on the material and required structure of the scintillator nanocrystals. FIG. 6 illustrates diffraction spectra measured for garnet nanoparticles annealed at different temperatures. From these spectra, it is seen that garnet nanocrystals are formed only if annealing is performed at temperatures above 1000° C. If the annealing temperature is lower, then the nanocrystals of perovskite YAlO₃ are formed (at 900° C.) or nanoparticles preserve their amorphous structure (at 700° C. and 800° C.). For YAG:Ce (1 at %) nanoparticles annealed at 1100° C. in the air, it was observed that the general size of the formed nanocrystals was very close to the size of the nanoparticles obtained from the nanoparticle synthesis. Also, these nanocrystals have cubic symmetry that is usual for the materials with garnet structure.

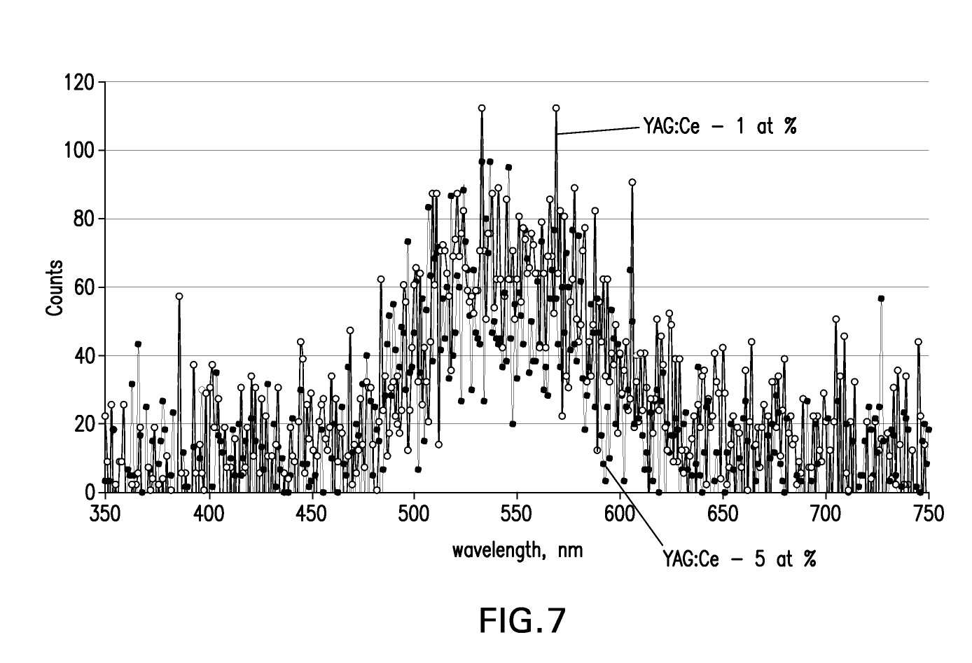

Radioluminescence spectra measured for synthesized nanocrystals of garnet material with different concentrations of Ce are illustrated in FIG. 7. The spectra were obtained for YAG:Ce (1 at %) and YAG:Ce (5 at %) using a ⁵⁷Co (22 keV) gamma ray source and indicate that obtained nanocrystals are nanocrystals of scintillation material.

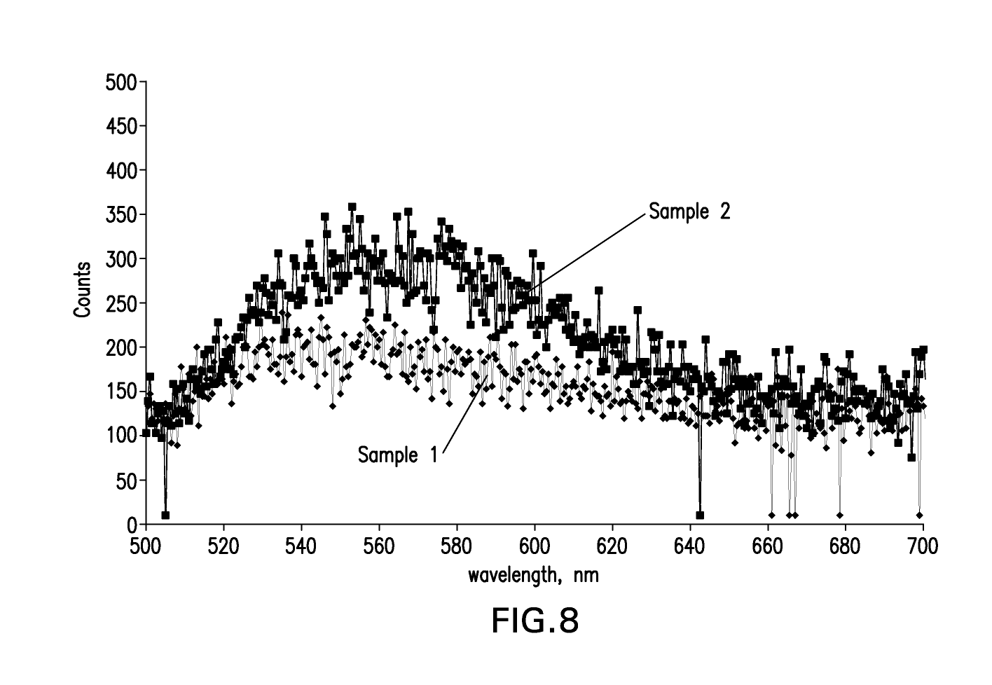

To synthesize nanostructured scintillation material under consideration, nanocrystals of YAG:Ce scintillator are mixed with the glass matrix material with the general composition SiO₂ (20-30%)-B₂O₃ (25-50%)-Al₂O₃ (0-10%)-Y₂O₃ (20-30%)-MgO (12-15%)-CeO₂ (3-5%). The synthesis is performed according to the temperature program shown in FIG. 5 where T_{g}=500° C., Tₚ=1450° C. and T_{c}=700° C. FIG. 8 illustrates radio luminescence spectra measured for nanostructured scintillation materials synthesized from glass matrix material with the composition SiO₂ (20%)-B₂O₃ (30%)-Y₂O₃ (27%)-Al₂O₃ (5%)-MgO (15%)-CeO₂ (3%) mixed with 10 weight % of Y₃Al₅O₁₂:Ce nanocrystals (Sample 1) and from glass matrix material with the composition SiO₂ (20%)-B₂O₃ (30%)-Y₂O₃ (30%)-Al₂O₃ (0%)-MgO (15%)-CeO₂ (5%) mixed with 5 weight % of Y₃Al₅O₁₂:Ce nanocrystals (Sample 2). The radioluminescence spectra were measured after Stage 1 and Stage 2 of the material synthesis. No radioluminescence was observed in the samples after Stage 1. The presence of the radioluminescence signal in the wavelength range characteristic for YAG:Ce scintillation was observed for these two samples. This indicates that the recrystallization of garnet nanocrystals takes place during Stage 2 of material synthesis. The increase of the concentration of garnet nanocrystals in the initial mixture causes some increase of the radioluminescence yield (see FIG. 8) indicating that this leads to the increase of the nanocrystal concentration in the synthesized glass.

From the data presented above, it is demonstrated that it is possible to synthesize nanostructured glass scintillation material which would consist of scintillator nanocrystals impregnated into a glass matrix having a neutron interaction material such as Boron-10. Considered glass is synthesized at Tₚ=1450° C. in one or more embodiments. In spite of the melting point of YAG:Ce being Tₘ=1870° C., even such a large difference between and Tₚ=1450° C. and Tₘ=1870° C. could not prevent the dissolution of nanocrystals in molten glass matrix during Stage 1 of material synthesis. Ce³⁺ ions used as an activator in scintillator nanocrystals also migrate away from the nanocrystals deep into the glass matrix and as a result it is difficult to restore high Ce³⁺ concentration in nanocrystals during their recrystallization at Stage 2 of the glass synthesis. These phenomena are due to different solubilities of activator material in nanocrystals and glass matrix at Tₚ and T_{c}. Different materials such as YAl₃(BO₃)₄, Y(Al—Sc)₃(BO₃)₄ and (Al—Sc)₃(BO₃)₄ doped with Ce have melting points near 1350° C., which is closer to the Tₚ temperature for boron-based glass in comparison with the crystallization temperature of garnets. As a result, two opposite processes of dissolving of nanocrystals and their recrystallization will take place in parallel at Stage 1 of the synthesis. Thus, a larger fraction of nanocrystals will be preserved in the glass matrix during the glass melting and that will provide better scintillation properties to the synthesized nanostructured glass.

An alternative way to improve the performance of nanostructured glass is to replace Y₂O₃ in the glass matrix material with Gd₂O₃. High concentration of Gd³⁺ ions causes the formation of a subzone in the forbidden zone in the electronic structure of the matrix and this subzone promotes the transfer of low energy excitation to luminescent Ce³⁺ ions. Light yield of the glass obtained from the mixture of glass matrix material SiO₂(25%)-B₂O₃(30%)-Gd₂O₃(30%)-MgO (15%) with 10 weight % of Y₃Al₅O₁₂:Ce nanocrystals (Sample 3) is six times larger than the LY observed for Samples 1 and 2 discussed above. At the same time, it should be pointed out that natural Gd has a very high neutron absorption cross section due to neutron absorption without emission of a high energy charged particle by the ¹⁵⁷Gd isotope. Thus, for nanostructured scintillation glass with Gd in the glass matrix used for neutron detection, purified Gd with very low concentration of ¹⁵⁷Gd isotope is used for its synthesis.

If Stage 1 of neutron detection uses reaction (1), then the glass matrix should be made of a glass matrix having a substantial concentration of lithium such as a lithium-magnesium glass. In one or more embodiments, the lithium-magnesium glass has the general formula of Li₂O—Al₂O₃—MgO with addition of CeO₂ or Eu₂O₃. The choice of scintillator nanocrystals should be defined by the compatibility of the nanocrystals with the glass matrix according to the material synthesis process such as described in FIG. 5 and processes of Ce ion migration between nanocrystals and glass matrix. For example, nanocrystals of LiAlSiO₄, LiAlSi₂O₆ or LiAlSi₄O₁₀ compounds doped with Ce can be used as scintillation nanocrystals to obtain lithium based glasses impregnated with those nanocrystals of scintillation material.

It can be appreciated that crystals are just one type of a nanoparticle and that nanoparticles having scintillation properties can also be impregnated or distributed throughout the neutron absorber matrix material. One skilled in the art will know that nanoparticles are very small objects that are measured in nanometers. Nanoparticles can range in diameter from one nanometer to a hundred or more nanometers, but are generally less than one micron for purposes of this disclosure. It can be appreciated that while the neutron absorber material disclosed above is in the embodiment of a glass matrix, other embodiments of material transparent to light other than glass can also be used.

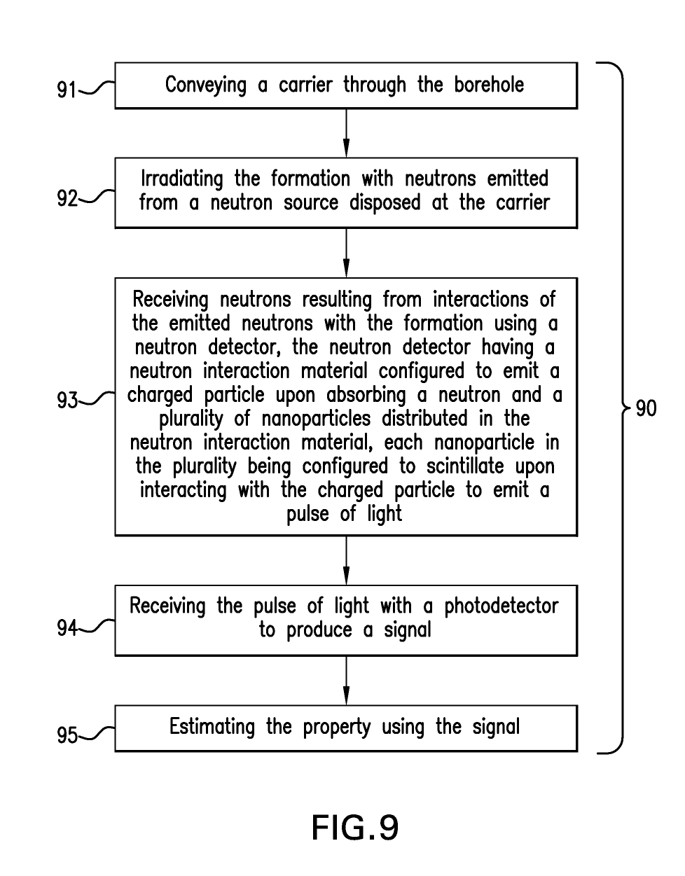

FIG. 9 presents one example of a method 90 for estimating a property of an earth formation penetrated by a borehole. The method 90 calls for (step 91) conveying a carrier through the borehole. Further, the method 90 calls for (step 92) irradiating the formation with neutrons emitted from a neutron source disposed at the carrier. Further, the method 90 calls for (step 93) receiving neutrons resulting from interactions of emitted neutrons with the formation using a neutron detector. The neutron detector is made of a neutron interaction material configured to emit a charged particle upon absorbing a neutron. The neutron interaction material is impregnated with nanoparticles configured to scintillate upon interacting with the charged particle to emit a pulse of light. Further, the method 90 calls for (step 94) receiving the pulse of light with a photodetector to produce a signal. Further, the method 90 calls for (step 95) estimating the property using the signal.

In support of the teachings herein, various analysis components may be used, including a digital and/or an analog system. For example, the downhole electronics 11 or the surface computer processing 12 may include the digital and/or analog system. The system may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, a power supply (e.g., at least one of a generator, a remote supply and a battery), cooling component, heating component, magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

The term “carrier” as used herein means any device, device component, combination of devices, media and/or member that may be used to convey, house, support or otherwise facilitate the use of another device, device component, combination of devices, media and/or member. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order. The term “couple” relates to coupling a first component to a second component either directly or indirectly through an intermediate component.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for detecting a neutron, the apparatus comprising:
a neutron interaction material configured to emit a charged particle upon absorbing a neutron;
a plurality of nanoparticles distributed in the neutron interaction material, each nanoparticle in the plurality being configured to scintillate upon interacting with the charged particle to emit a pulse of light;
a photodetector coupled to the neutron interaction material and configured to receive the pulse of light and generate a signal based on the received pulse of light; and
a processor configured to receive the signal in order to detect the neutron.

2. The apparatus according to claim 1, where in the neutron interaction material comprises a glass.

3. The apparatus according to claim 2, wherein the neutron interaction material comprises Boron-10.

4. The apparatus according to claim 2, wherein the neutron interaction material comprises Lithium-6.

5. The apparatus according to claim 1, wherein the nanoparticles are nanocrystals.

6. The apparatus according to claim 5, wherein the nanocrystals are grown from seeds disposed in the neutron interaction material.

7. The apparatus according to claim 5, wherein the glass is synthesized from a mixture of the neutron interaction material and the nanocrystals.

8. The apparatus according to claim 1, wherein the nanoparticles comprise Ce.

9. The apparatus according to claim 1, wherein the nanoparticles comprise Eu.

10. An apparatus for estimating a property of an earth formation penetrated by a borehole, the apparatus comprising:
a carrier configured to be conveyed through the borehole;
a neutron source disposed at the carrier and configured to irradiate the formation with neutrons;
a neutron detector disposed at the carrier and configured to detect a neutron resulting from one or more interactions between the neutrons emitted from the neutron source and the formation, the neutron detector comprising a neutron interaction material configured to emit a charged particle upon absorbing a neutron and a plurality of nanoparticles distributed in the neutron interaction material, each nanoparticle in the plurality being configured to scintillate upon interacting with the charged particle to emit a pulse of light; and
a photodetector coupled to the neutron interaction material and configured to detect the pulse of light and generate a signal upon detecting the pulse of light;
wherein the signal is used to estimate the property.

11. The apparatus according to claim 10, further comprising a processor coupled to the photodetector and configured to estimate the property using the signal.

12. The apparatus according to claim 10, wherein the property is density or porosity.

13. The apparatus according to claim 10, wherein the carrier comprises a wireline, a drill string or coiled tubing.

14. A method for estimating a property of an earth formation penetrated by a borehole, the method comprising:
conveying a carrier through the borehole;
irradiating the formation with neutrons emitted from a neutron source;
receiving neutrons resulting from interactions of the emitted neutrons with the formation using a neutron detector, the neutron detector comprising a neutron interaction material configured to emit a charged particle upon absorbing a neutron and a plurality of nanoparticles distributed in the neutron interaction material, each nanoparticle in the plurality being configured to scintillate upon interacting with the charged particle to emit a pulse of light;
receiving the pulse of light with a photodetector to produce a signal; and
estimating the property using the signal.

15. The method according to claim 14, wherein a diameter of the nanoparticles in the plurality of nanoparticles is at least four times smaller than a wavelength of light emitted by the scintillation of the nanoparticle upon interaction with the charged particle.

16. The method according to claim 14, wherein the neutron interaction material comprises a glass.

17. The method according to claim 16, wherein the nanoparticles comprise nanocrystals impregnated in the glass.

18. The method according to claim 17, further comprising growing the nanocrystals from seeds disposed within the neutron interaction material.

19. The method according to claim 17, further comprising synthesizing the glass from a mixture of the neutron interaction material and the nanocrystals.
